(19) United States
(12) Patent Application Publication
(10) Pub. No.: US 2002/0158129 A1
(43) Pub. Date: Oct. 31, 2002

(54) Picture changer with recording and playback capability

(76) Inventor: Ron Hu, Gloucester (CA)

Correspondence Address: ROTHWELL, FIGG, ERNST & MANBECK, P.C., 1425 K STREET, N.W., SUITE 800, WASHINGTON, DC, 20005, US

(21) Appl. No.: 09/808,353

(22) Filed: Mar. 15, 2001

(51) Int. Cl. G06K 7/10; G06K 15/00; B65H 83/00; B65H 85/00; B65G 1/16; B65H 1/06; G10L 13/00; G10L 13/08; G06K 9/00

(52) U.S. Cl. 235/462.11; 235/470; 235/462.41; 235/462.43; 235/462.32; 271/3.05; 271/165; 271/212; 312/34.4; 312/42; 312/122; 312/126; 312/138.1; 704/260; 382/100; 40/513

(57) ABSTRACT

A display apparatus (18) capable of sequentially displaying a plurality of annotated image prints (36), each image print having audio data encoded (54) and made integral its back surface (46), thereby providing a convenient way to both display image prints and play back audio data associated with image prints. In one aspect of the present invention, the display apparatus (18) also records audio data for a plurality of image prints and provides a handwritten means to electronically associate a particular image print with its respective audio recording.

This invention relates to a method and apparatus for displaying image prints and for recording and playback of annotation where such annotation is made integral to the image prints.

### BACKGROUND OF THE INVENTION

Image annotation is the process of adding supplemental information relating to an image print for the purpose of enhancing enjoyment or for future reference. As such, the ability to record and playback annotation relating to image prints has broad applications in many different fields. For example, in the field of photography, recording of one's own voice annotation that can later be played back enhances one's enjoyment and memory recollection of the events surrounding the photos. In the field of tourism, post cards that can bear audio narration can serve as a tour guide of the places to visit and memorabilia to keep afterwards. In the field of children's education, picture cards that can narrate their story lines provide a fun way for children to learn reading skills.

There have been various past attempts to record and playback annotation on traditional photographic prints. Numerous prior art references teach the use of a separate storage medium such as magnetic disc, tape, electronic memory element or optical memory element to hold sound information. The sound information is then logically associated with the photographic prints through a specialized album or display apparatus. The disadvantage of this approach is that the sound storage media can become easily disassociated with the photographic prints through handling. The storage media is also susceptible to being physically lost, destroyed or erased. Other prior art references teach integrating sound information with the image prints. This approach eliminates the risk of separation and mix-up of audio information from the image prints, and is the subject of the following discussion.

Within this approach, various methods of integrating magnetic, semiconductor and optical memory containing sound information with the image print are found in the prior art. In addition, a number of prior art references teach the use of optical encoding directly on a media without the use of a separate storage means. Some of the prior art disclosing the magnetic methods of storage are as follows:

In U.S. Pat. No. 4,270,854 issued to Stemme, et al. on Jun. 2, 1981, sound is recorded on an instant print by placing the print, after it has been ejected, into an auxiliary slot in the camera and then proceeding to record the audio on a magnetic strip integral to the print border. The only method disclosed for playback is with the camera.

Similarly, in U.S. Pat. No. 4,905,029 issued to Kelly on Feb. 27, 1990, sound is recorded using a magnetic strip which is either integrally formed with instant print material or is separable for later attachment. It provides a limited audio storage space and is awkward to reproduce the sound while viewing the print. It requires a magnetic reader head employing relative motion between the head and magnetic strip for signal reproduction. This system is prone to mechanical failure.

Also, U.S. Pat. No. 5,920,737 issued to Marzen et al. on Jul. 6, 1999 discloses an apparatus that has a recording/applicator mechanism which applies a recorded magnetic tape strip to photographs automatically when the photograph is positioned within the applicator mechanism. Unfortunately, all such magnetic recording media have a limited life span that includes inherent loss of the magnetically recorded data over time.

Some other prior art references disclosing the semiconductor memory methods are as follows:

U.S. Pat. No. 5,365,686 to Scott, issued Nov. 22, 1994, shows a U-shaped plastic sleeve for holding a photograph, which sleeve includes an integral IC memory chip into which audio data can be recorded and from which it can be retrieved. The sleeve can be “plugged in” to a player whereby electrical contact is made with the player. This system has the disadvantage of added cost and bulk to the image prints.

Also, U.S. Pat. No. 5,878,292 to Bell et al, issued on Mar. 2, 1999, discloses the method of making of an image-audio print whereby the image print is adhesively attached to a backing containing audio storage means such as EPROM or EEPROM. When such image-audio print is inserted into a player, it makes electrical contact with the player's apparatus and thereby plays back the message stored in the integral audio storage. According to the invention, this backing material adds “heft” to the print. For many people, this added heft may be undesirable.

Still some of the other prior art references disclosing the optical methods are as follows:

U.S. Pat. No. 4,983,996 discloses a camera having a microphone which optically records sound data in a bar code pattern along the border of the film. The camera is provided with a detachably connectable bar code reader which is used, once the film is developed and printed, to scan the code along the print border to play the voice or sound recording associated with the print. This system provides for a limited amount of sound recording.

Also, U.S. Pat. No. 5,276,472, issued to Bell et al on Jan. 4, 1994, describes a sound capturing camera that first stores a sound record onto a transparent magnetic coating on the film. This sound record is then transferred to the back of a print with an ink jet printer or thermally formed blisters or writing the sound record as a bar code on the area adjacent to an image on the front of the print. A hand-held device is used on the print to read the sound record from the print and play back the sound record. This system requires writing the entire sound record on the print and in one case, proposes creating an unsightly pattern bearing the sound record adjacent to the image on the print.

U.S. Pat. No. 5,521,663, granted to Norris on May 28, 1996, discloses recording sound by the camera directly onto the film using a latent image binary code. The binary code is imaged onto the print at the time the print is exposed. The code is decoded into sound by a scanner in the playback device. This system uses up valuable image area on the image print for the sound code.

Further, U.S. Pat. No. 5,995,193 issued to Stephany et al on Nov. 30, 1999, discloses a self-contained device for recording and playback of data on a medium such as photographic print. The recording can be done in either or both visible and invisible ink and playback can detect either or both visible and invisible ink. A print is inserted into the device for recording and playback. This device is not suitable for portable enjoyment of sound reproduction.

Similarly, U.S. Pat. No. 6,094,279 to Soscia, issued Jul. 25, 2000, discloses the use of a printed invisible encodement on a photographic image to record sound information. The invisible image is produced by development of a photographic emulsion layer, inkjet printing, thermal dye transfer printing or other printing method. The encodement is a one or two-dimensional array of encoded data. This approach requires printing on the face of the photographic prints, and to avoid problems, the materials used, including materials in the layers of the photographs, are selected to avoid undesirable interactions. This is acceptable for new prints, but is difficult to adapt for existing prints. It is also likely that for many people, subjecting valued photographs to an elective modification, thus risking even a small chance of damage or loss, is unacceptable.

From the above, it is clear that there is a desire to associate sound and other data with print images. Unfortunately, as indicated above, each of the aforementioned systems has one or more disadvantages.

### BRIEF SUMMARY OF THE INVENTION

Briefly summarized, the main object of the present invention is to overcome the above shortcomings by providing an apparatus and method for encoding annotation that can be made integral to both new and existing image prints, and to provide a portable, self-contained device for displaying and playing back a plurality of such annotated image prints.

Several advantageous features of the preferred embodiments of the present invention are as follows:

(a) the apparatus and method for annotating photographic prints is compatible with both existing and newly processed prints;

(b) the apparatus and method for annotating a photographic print provides annotation that is made integral to the print thereby precluding the annotation from becoming separated from the print;

(c) the apparatus and method of annotating a photographic print produces no obtrusive markings on the image surface of the print during the annotation process so as to avoid detracting from enjoyment of the image;

(d) the apparatus and method for annotating a photographic print produces annotation that will last as long as the photographic print itself and not be degraded significantly with use or over time, nor be subject to accidental erasure;

(e) the annotation produced on photographic prints is retrieved through non-contact means so as to avoid physical degradation of the prints or the annotation;

(f) the apparatus will make available, for audio annotation on photographic prints, at least 10 seconds of recording per photographic print;

(g) the apparatus holds a plurality of photographic prints which, when actuated by a user, displays each print successively while playing back annotation associated with the particular print, thereby enhancing the viewing enjoyment of each print;

(h) the apparatus for retrieving annotation on photographic prints that is portable and battery operated;

(i) the apparatus includes means for recording annotation corresponding to photographic prints and for storing the recorded annotation along with the corresponding prints within the apparatus;

(j) the apparatus includes a detachable storage element which holds stored annotation;

(k) the method and apparatus include means whereby the ordinary user can annotate photographic prints at home without need of any elaborate equipment;

(l) the method and apparatus include means for annotating photographic prints with human readable information;

(n) the method and apparatus include means whereby the annotation on a photographic print is retrievable even when the prints are mounted in a photo album;

(o) the apparatus is capable of generating synthesized speech thereby allowing playback of annotation comprising longer audio messages than digitized audio;

(p) the apparatus is capable of transferring annotation data to an external device;

(q) the apparatus is further capable of interacting with a user through a touch screen; and

(r) the apparatus is also capable of electronically displaying information to a user.

Further advantages of preferred embodiments of the present invention are as follows:

(a) a system is provided that is compatible with commercially available image printing devices, thus obviating the need for the development and manufacture of specialized printing machinery;

(b) the apparatus for displaying photographic prints and playing back annotation on those prints that is durable and reliable;

(c) the apparatus and method for annotation photographic prints and playing back said annotation is inexpensive to manufacture, and accordingly will sell at a low price, thereby making such photograph annotation and display apparatus economically available to the average consumer.

Further objects and advantages of the present invention will be apparent from the following description and the appended drawings, wherein preferred embodiments of the invention are clearly described and shown.

### BRIEF DESCRIPTION OF THE DRAWINGS

The present invention will be further understood from the following description with reference to the drawings in which:

FIG. 1 is a perspective view of the display apparatus of a preferred embodiment of the present invention, facing up with the drawer fully open.

FIG. 2A is a perspective view of the apparatus shown in FIG. 1, facing down with the drawer fully closed.

FIG. 2B is the display apparatus shown in FIG. 2A with the controller housing separated from the frame housing.

FIG. 3 is a cross-sectional view of the display apparatus shown in FIG. 2A along line 3-3.

FIG. 4 is an exemplary representation of the back surface of an image print used in the display apparatus shown in FIG. 1.

FIG. 5 is a block schematic diagram of the electrical subsystem of the display apparatus shown in FIG. 1.

FIG. 6 is a logic flow diagram showing the operation of the display apparatus shown in FIG. 1.

FIG. 7 is a perspective view of a further preferred embodiment of the display apparatus of the present invention, facing up.

FIG. 8 is an exemplary representation of the back surface of an image print used in the preferred embodiment of the present invention shown in FIG. 7.

FIG. 9 is a block schematic diagram of the electrical subsystem of the preferred embodiment of the display apparatus of the present invention shown in FIG. 7.

FIGS. 10A and 10B are logic flow diagrams showing the operation of the preferred embodiment of the display apparatus of the present invention shown in FIG. 7.

### REFERENCE NUMERALS SHOWN IN DRAWINGS

18 display apparatus

20 frame housing

21 print holder

22 controller housing

23 controller

24 sliding drawer

26 viewing aperture

28 side walls

30 front wall

32 floor

33 opening in the floor

34 slot

36 a stack of image prints

38 loudspeaker

40 supporting surface

41 separator bar

42 drawer switch

43 actuating lever

44 arrow

46 a back surface of an image print

48 the bottom-most image print

49 the top-most image print

50 arrow

52 scanning window

54 encoded data

56 mirror

58 image sensor

59 illuminator

60 optical path

61 optical path

66 human readable information

72 processor

74 nonvolatile memory

76 random access memory

77 read-only memory

78 audio amplifier

80 digital signal processor

82 batteries

90 microphone

92 record switch

94 transceiver

96 data connector

100 picture ID (PID)

110 routine to process PID information

112 routine to perform audio recording

### Glossary

The following are definitions of terms used in the ensuing description and are provided to aid in understanding the applicant's invention.

IMAGE PRINT: The most common form being a photographic print, but may also be any printed sheet from which a visual image can be perceived, such as post cards, picture cards, flash cards, drawings, letterings and the like.

ANNOTATION: Information related to an IMAGE PRINT. Annotation may comprise human readable information and machine-readable data. Human readable information may comprise text, handwritings, drawings and the like. Machine-readable data, embodied in a storage means, may comprise sound data, machine data, text data and the like. Sound data may comprise human speech, voice, singing, music, animal noises, synthesized speech, synthesized sounds and the like. Machine data may comprise binary data, machine instructions and the like.

AUDIO DATA: Sound data that is digitized and compressed for digital storage and transmission.

ENCODED DATA: machine-readable data embodied in a two-dimensional symbology and printed on a sheet.

The following descriptions of the embodiments of the present invention refer to various conventions such as “top”, “bottom”, “upper”, “lower”, “under”, “underside”, etc. These descriptors are made only to provide a frame of reference and should not limit the description provided herein. Although the present invention references image prints as photographic prints, and annotation as human speech or voice, it should be understood that other forms of image print and annotation as described in the Glossary definitions contained herein can be utilized with the present invention.

### DETAILED DESCRIPTION OF THE PREFERRED EMBODIMENTS OF THE INVENTION

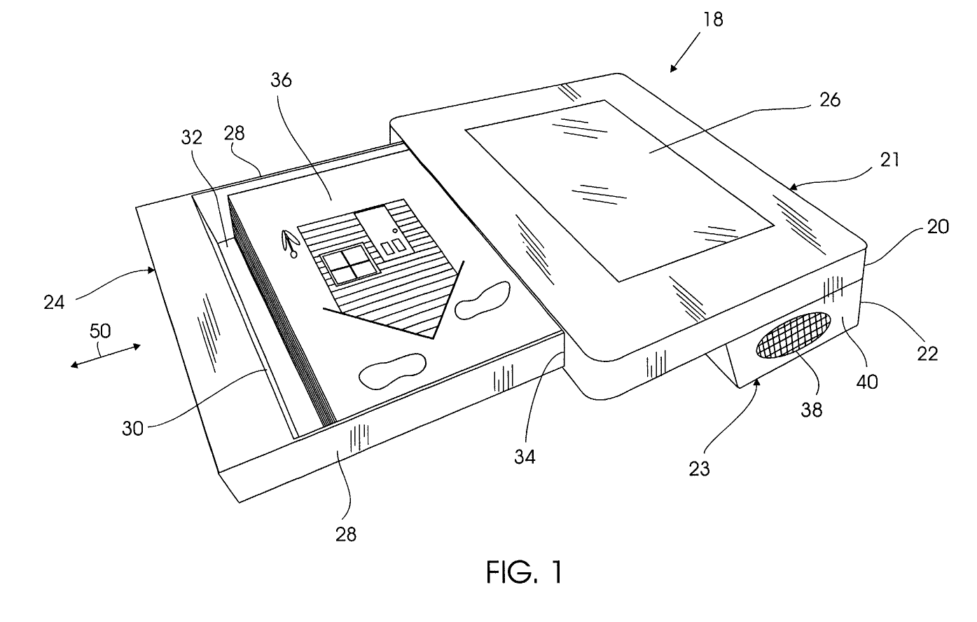

### Description of a First Preferred Embodiment—FIGS. 1 to 6

With reference to FIGS. 1 to 6, a first preferred embodiment of the present invention will be described in detail as this will facilitate the understanding of further preferred embodiments described later.

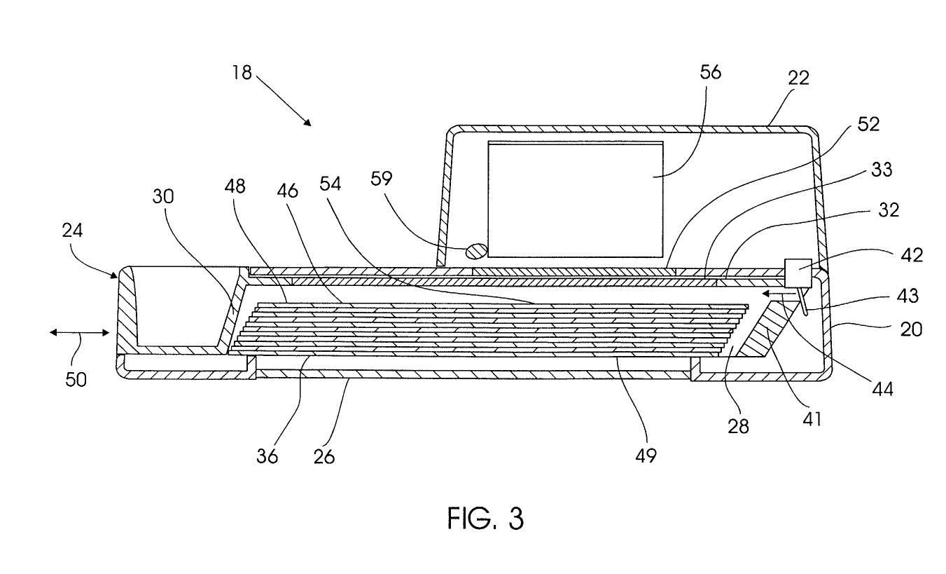

Referring to FIG. 1, a display apparatus 18 comprises two main parts, a print holder 21 and a controller 23. The print holder 21 comprises a frame housing 20 with a viewing aperture 26 made of a clear or transparent plastic material and a sliding drawer 24 which is slidably engageable within frame housing 20. Sliding drawer 24 is preferably a one-piece element having a floor 32, a pair of side walls 28, a front wall 30 joining side walls 28 and a separator bar 41 (shown in FIG. 3) which altogether form a drawer-like structure. Sliding drawer 24 is made to be slidably engageable within a defined slot 34 in frame housing 20 in the directions shown by an arrow 50. Sliding drawer 24 can be pulled out of frame housing 20 for a distance limited by stop members (not shown) on separator bar 41 and complementary stop members (not shown) on frame housing 20. Sliding drawer 24 is sized for receiving and supporting a stack of image prints 36 arranged therein for display through viewing aperture 26. Viewing aperture 26, is made with clear or transparent plastic material, and is sized to display the individual image prints from the stack of image prints 36. Additional details relating to the structure of frame housing 20 and sliding drawer 24 are described in greater detail in U.S. Pat. No. 4,939,860, issued to P. Ackeret and assigned to Licinvist, AG which is hereby incorporated by reference. Controller 23 comprises a controller housing 22 and parts contained therein. An audio loudspeaker 38 attaches to an exterior supporting surface 40 of controller housing 22. Controller housing 22 attaches to the bottom of frame housing 20. Both frame housing 20 and controller housing 22 are preferably formed from injection-molded plastic.

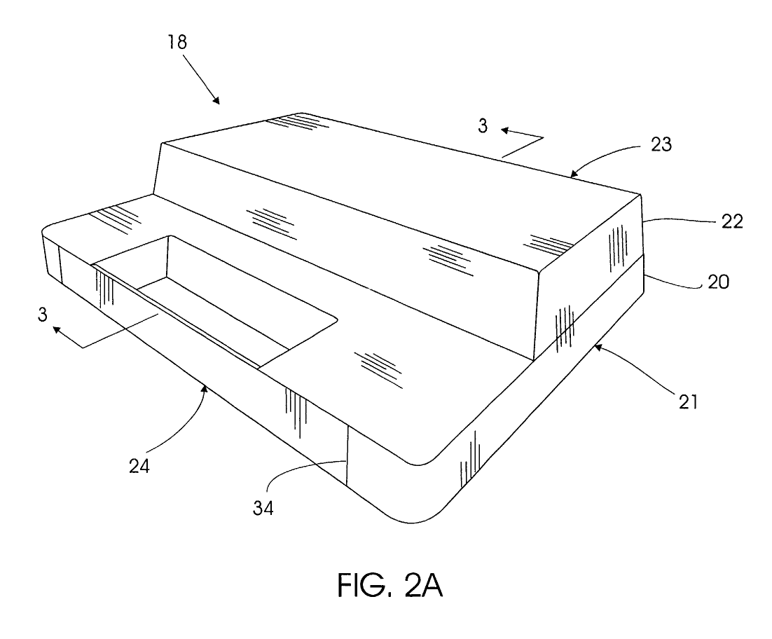

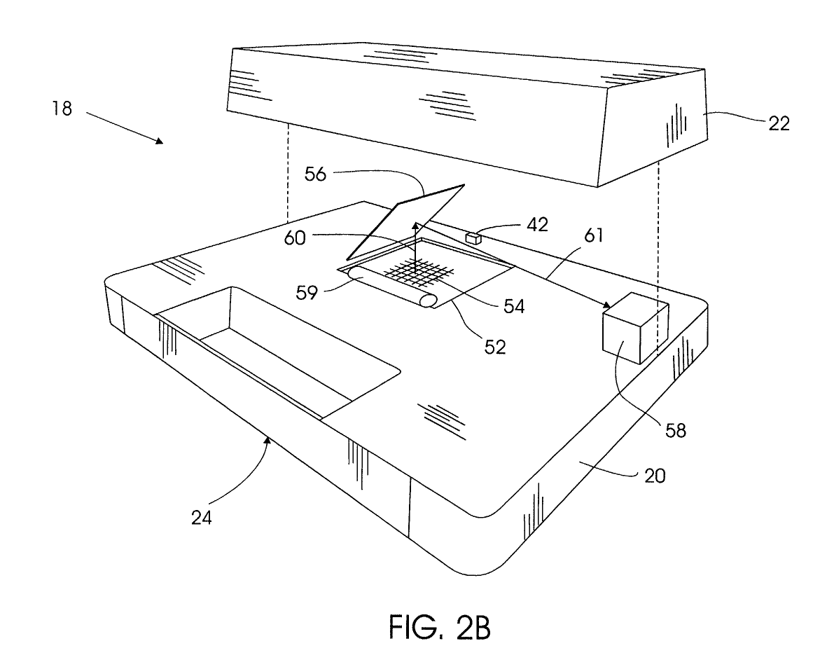

FIG. 2A is an underside view of display apparatus 18, showing controller 23, controller housing 22, print holder 21, frame housing 20, sliding drawer 24 in a fully closed position, and slot 34 in frame housing 20. FIG. 2B shows display apparatus 18 of FIG. 2A with controller housing 22 separated to expose optical related components contained therein. The optical components contained in controller housing 22 include an image sensor 58, a mirror 56 fixed at a predetermined angle and positioned above a scanning window 52, an illuminator 59 at one edge of scanning window 52, and another identical illuminator (not shown for simplification) at an opposite edge of scanning window 52. Image sensor 58 comprises a solid-state sensor and a predetermined lens to attain focus and a substantially full-image view of an encoded data 54 along an optical path 60, 61. Mirror 56 is a front-surface or first-surface type to minimize light loss and secondary refraction. Illuminator 59 comprises a bank of light-emitting diodes (LEDs) mounted in close proximity to each other so as to cast a uniform illumination on encoded data 54 on a back surface 46 (see FIG. 3) of a bottom-most image print 48. Alternatively, illuminator 59 may be any other light emitting devices capable of illuminating encoded data 54. A drawer switch 42 is positioned to sense the opening and closing of sliding drawer 24.

Mirror 56 is used to keep the profile or the thickness of display apparatus 18 to a minimum so it can be grasped easily with one hand. Without mirror 56, image sensor 58 would need to be located directly behind scanning window 52 at a distance equal to optical paths 60, 61. An alternative means of achieving a low profile is to use a linearly translating scanning mechanism (not shown) directly above scanning window 52 to perform the function of image scanning. Such a linear translating scanning mechanism can be based on the same principle as those found in desktop flatbed scanners, utilizing a charge-couple device (CCD) sensor or contact image sensor (CIS) mounted on a motorized moving carriage (not shown). Motorization of the carriage would not be required if the carriage is affixed (not shown) to sliding drawer 24 such that the action of pulling-out/pushing-in sliding drawer 24 by the user achieves the linear translating motion necessary for scanning. These techniques of scanning are conventionally known to those skilled in the art. In a further alternative, image sensor 58 can be located in close proximity to scanning window 52 through the use of a wide-angle lens (not shown). A wide-angle lens can introduce spherical distortion, however, appropriate use of mathematical algorithms known in the art, can correct for such distortion.

FIG. 3 shows a cross-sectional view of display apparatus 18 along line 3-3 of FIG. 2A. In this face down view, sliding drawer 24 is fully engaged within frame housing 20. While in this position, separator bar 41, which forms the innermost part of the drawer-like structure, engages an actuating lever 43 of drawer switch 42. Actuating lever 43 is spring-loaded against separator bar 41 in the direction shown by an arrow 44. With sliding drawer 24 fully engaged within frame housing 20 as shown in FIG. 3, drawer switch 42 is electrically open. When sliding drawer 24 is disengaged from frame housing 20 as shown in FIG. 1, drawer switch 42 is electrically closed, or activated. The stack of image prints 36 is loaded within sliding drawer 24. A top-most image print 49 is visible through viewing aperture 26. Encoded data 54 imprinted on back surface 46 of bottom-most image print 48 is exposed to mirror 56 through an opening 33 in floor 32 of sliding drawer 24 and through scanning window 52. Controller housing 22, which is attached to the underside of frame housing 20 holds front-surface mirror 56 at a predetermined angle.

In summary, the optical elements described herein allow an image of encoded data 54 to travel along optical path 60, 61, first through opening 33 in floor 32 of sliding drawer 24, then through scanning window 52, then reflecting off front-surface mirror 56 and finally striking image sensor 58.

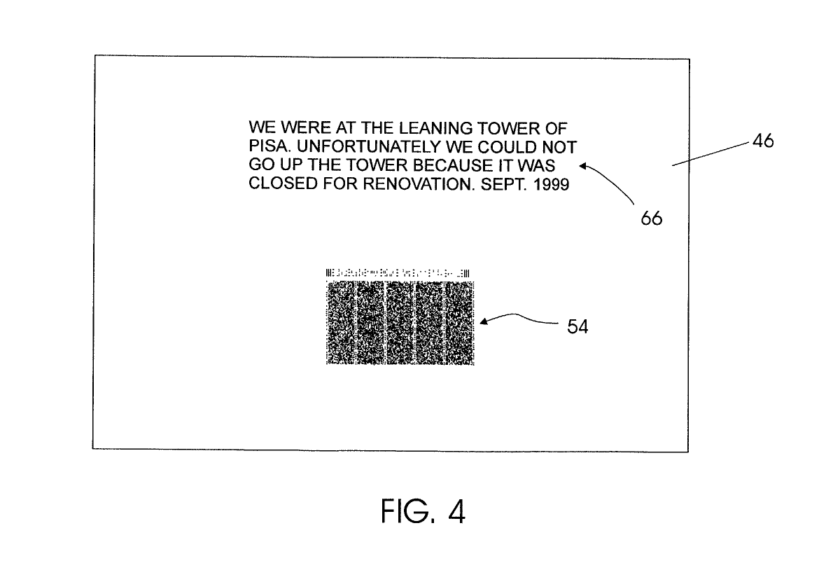

FIG. 4 shows an exemplary imprinting on back surface 46 of an image print. A human readable information 66, along with encoded data 54 containing audio data, are disposed substantially in the same location on each image print of the stack of image prints 36. More specifically, encoded data 54 is located on the image print where it will be substantially centered within scanning window 52 when the image print is at the bottom of sliding drawer 24, and sliding drawer 24 is fully engaged within frame housing 20. The format of encoded data 54 may be any two-dimensional encodement having the capacity to hold digitized human speech as described in more detail below. Preferably, the encodement format is that of PaperDisk™ marketed by Cobblestone Software, Inc., of Lexington, Mass. An example of PaperDisk™ encodement format is shown by encoded data 54 in FIG. 4. Alternatively, two-dimensional high-density bar code formats may also be utilized such as Aztec Code, SuperCode, Data Matrix and QR Code which are conventionally known to those skilled in the art. In general, encoded data 54 holds at least 2,000 bytes, preferably at least about 4,000 bytes and most preferably at least about 6,000 bytes of digital information. The imprinting process may be done at the user's own premise using a computer, a printer and a predetermined software, or as a step in the photo finishing process of the photographic print by the photo finishing laboratory. Encoded data 54 is made integral to back surface 46 either by being imprinted directly on back surface 46 of an image print by a printing device (not shown) or by being imprinted on an adhesive label (not shown) first and then affixed to back surface 46 of an image print. Furthermore, while encoded data 54 can be visible or discernible by the naked eye, it need not be. Encoded data 54 may be imprinted with ink or dye that is either within or outside the visible wavelength range, where the visible wavelength is considered to be about 400 to about 700 nanometers. In such case, image sensor 58 will need to be responsive to the selected wavelengths and illuminator 59 must be chosen to excite the corresponding wavelengths.

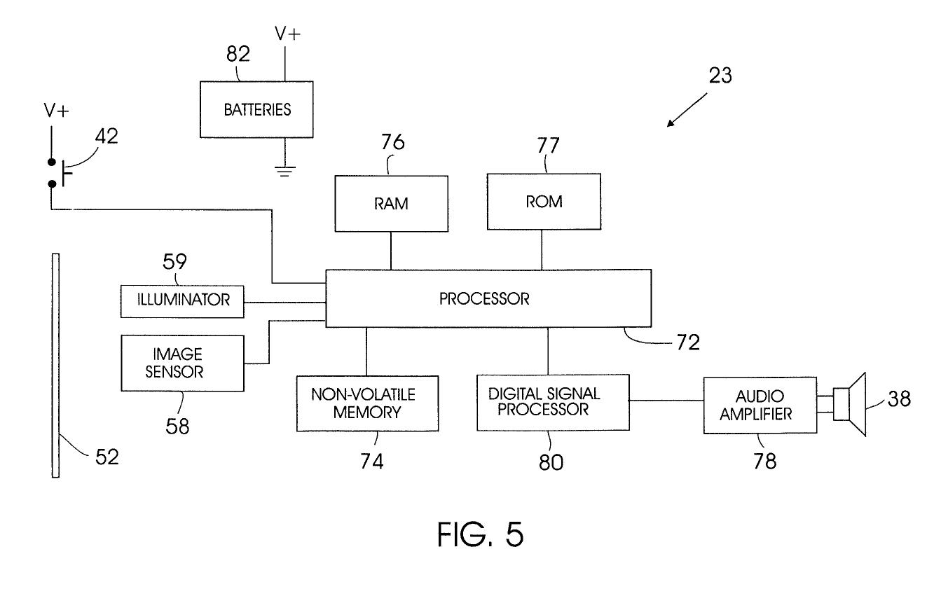

FIG. 5 shows the main electrical components of controller 23 which are contained within controller housing 22. A power supply, in the form of batteries 82, supplies all the power to controller 23. A processor 72 coordinates the overall task of scanning, decoding and playing back of audio data. Preferably, processor 72 is a low-cost 8-bit or 16-bit microprocessor, and most preferably one of the family of 80C51 or its derivatives manufactured by Intel Corporation and others. Drawer switch 42, which is positioned to sense the opening and closing of sliding drawer 24, is interconnected to processor 72 to act as a power-up and start-up signal to processor 72 when activated. While deactivation of drawer switch 42 does not put processor 72 back into power-down mode, any re-activation of drawer switch 42 while processor 72 is powered on does force processor 72 to restart from the beginning.

A nonvolatile memory 74 provides the means to retain data when processor 72 goes into power-down mode. Two discrete memory areas are logically allocated within nonvolatile memory 74 for holding audio data associated with two particular image prints: an Area B (not shown) to hold audio data associated with the current bottom-most image print 48 (see FIG. 3), and an Area T (not shown) to hold audio data associated with the current top-most image print 49 (see FIG. 3). Top-most image print 49 is the print visible at viewing aperture 26. A random access memory (RAM) 76 provides temporary working memory for processor 72. Unlike nonvolatile memory 74, the content of random access memory 76 is lost when processor 72 goes into power-down mode. A read-only memory (ROM) 77 stores the machine code routines for execution by processor 72, such as the algorithm for decoding encoded data 54.

Illuminator 59 comprises a bank of light-emitting diodes (LEDs) mounted in close proximity to each other so as to cast a uniform illumination on encoded data 54. Under the control of processor 72, illuminator 59 is activated while image sensor 58 scans an image of encoded data 54 through scanning window 52. Processor 72 turns off illuminator 59 when not used to conserve batteries 82. Alternatively, illuminator 59 may be any other light emitting devices capable of illuminating encoded data 54. Image sensor 58 comprises a solid-state sensor and a predetermined lens to attain focus and a substantially full-image view of encoded data 54 along optical paths 60, 61. Preferably, the solid-state sensor is the OV7110 sensor manufactured by OmniVision Technologies, Inc. of Sunnyvale, Calif. The OV7110 is a low-cost monochrome single-chip CMOS sensor with digital output lines that allow direct external access to video data and has a resolution of 644 by 484 pixels. The scanned image of encoded data 54 from image sensor 58 is stored in random access memory 76 while processor 72 decodes encoded data 54.

A digital signal processor (DSP) 80 comprises a codec (coder/decoder) to compress and decompress audio and an analog-to-digital/digital-to-analog (A/D-D/A) converter. Preferably, the codec is a chip-set solution based on Cybit ASC101A low rate audio coder as implemented in the ASM100 Vocoder Module manufactured by Cybernetics InfoTech, Inc. of Rockville, Md. Cybit ASC101A features high-compression scalable audio data rates from 0.9 Kbits per second to 2.8 Kbits per second. These are very low audio bit rates by industry standards. For example, telephone quality codec typically operates at 8,000 samples per second at 8-bit resolution which is equivalent to audio bit rate of 64 Kbits per second. As the reader will appreciate, the lower audio bit rate means lower audio quality. Nevertheless, at 2.0 Kbits per second, the ASC101A still achieves a high communication quality with Mean Opinion Score (MOS)=3.2. Mean Opinion Score was developed in the communications industry to determine the general acceptability or quality of voice communication systems or products. Evaluators rate the overall quality of speech/audio samples in a five-category rating scale with points assigned for each level as follows: 5—Excellent, 4—Good, 3—Fair, 2—Poor, and 1—Bad.

The A/D-D/A converter is conventionally known and preferably is a Texas Instrument TLC320AD50 chip or equivalent. Decompressed audio data is converted into an analog signal representative of the original audio by the D/A converter. This analog signal then goes to an audio amplifier 78 for amplification and then onto loudspeaker 38 for sound reproduction, both of these devices are conventionally known. It should be apparent from these descriptions that other devices capable of decompressing audio data can also be used; for example, other integrated circuit (IC) chips such as the family of TMS320C54X digital signal processors manufactured by Texas Instruments are also considered useful in addition to other numerous multi-IC component design alternatives which are conventionally known. It should also be understood that the functions of several of these chip sets may also be integrated into a single chip in the form of custom large scale integration (LSI). Alternatively, the compression/decompression of audio may also be implemented entirely in a software algorithm to be executed by processor 72.

Having described the main features of print holder 21 and controller 23, the factors affecting the audio data capacity will now be described, namely the resolution of image sensor 58, encodement format overhead and the audio data rate of digital signal processor 80.

Using the preferred image sensor 58 referenced above which has a resolution of 644 by 484 pixels, the theoretical maximum capacity of data decodable from image sensor 58 is 311,696 bits, or 38,962 bytes, provided that each and every data feature of encoded data 54 is mapped exactly and precisely to a corresponding pixel in image sensor 58 and each data feature has a binary value. In practice, this idealized capacity would not be attainable as every form of encodement must accommodate many real-world conditions and also carry overhead information necessary for its own identification and decoding. Using the preferred PaperDisk™ encodement format referenced earlier, some factors that reduce the theoretical maximum capacity are: (a) distortions and inaccuracies introduced by the optics of the described system and by image sensor 58; (b) misalignment between encoded data 54 and the field of view of image sensor 58; (c) quantization errors resulting from mapping data features to image sensor pixels especially where there is skew; (d) overhead of built-in error correction codes (ECC) to allow for data recovery in case of physical damage to encoded data 54; (e) overhead of identification markers in the encodement format to facilitate decoding, and the like. In practice, the net combined effect of these factors reduces the theoretical capacity by a factor of about 10. Hence the theoretical maximum capacity of 38,962 bytes equates to a practical maximum capacity of approximately 3,896 bytes. This capacity represents the practical amount of audio data one can encode on the back of an image print using the aforementioned image sensor 58 and the PaperDisk™ encodement format. Based on the data capacity of 3,896 bytes, TABLE 1 shows the relationship between the audio data rate and audio recording time using the preferred digital signal processor 80 referenced earlier.

TABLE 1

| Audio data rate | Audio recording time |
|---|---|
| 0.9 Kbits/sec | 34 seconds |
| 1.0 Kbits/sec | 31 seconds |
| 1.4 Kbits/sec | 22 seconds |
| 1.8 Kbits/sec | 17 seconds |
| 2.0 Kbits/sec | 15 seconds |
| 2.4 Kbits/sec | 13 seconds |
| 2.8 Kbits/sec | 11 seconds |

As noted in TABLE 1, if desired, there can be a trade off between audio quality and recording time. Preferably this optimization will be done automatically by the encoding software described in further detail below, whereby the highest audio rate will be automatically selected which meets the desired recording time. Preferably, an audio data rate of 2.0 Kbits/sec (with communication quality Mean Opinion Score of 3.2) or higher will be used, resulting in an audio message length of at least fifteen seconds per image print.

Even longer audio recording times can be attained through means (not shown) such as: (a) optimizing the optical components to increase accuracy and reduce distortion; (b) using image sensors with higher pixel resolution, for example, using an image sensor of 1024 by 768 pixels would represent an increase of two and half times the audio capacity over preferred image sensor 58 described above; (c) using each data feature to represent more than a binary value by using different levels of gray or by using different colors with a color image sensor; (d) using both visible and invisible ink or dye to imprint encoded data 54 to essentially multiply the data capacity; (e) using multiple encodings at multiple distinct wavelengths to essentially multiply the encoded data capacity, for example, putting one encoded data in red and another encoded data in green, and using an appropriate filter to read each of the encoded data; (f) using other encodement format offering higher density and capacity; (g) using other codec with higher compression at a higher MOS, and the like.

### Operation of First Preferred Embodiment—FIGS. 1 to 6

The operation of print holder 21 will be described first by reference to FIGS. 1 to 3. Print holder 21 is first prepared for use by loading a vertically arranged stack of image prints 36 into sliding drawer 24 which are supported therein by front wall 30, side walls 28, floor 32 and separator bar 41. Assume for the present description that back surface 46 of each image print is imprinted with encoded data 54 representing human speech. Sliding drawer 24, loaded with image prints 36 is then pushed into frame housing 20 through slot 34 as per arrow 50. Print holder 21 is now ready to successively display, one at a time, the stack of image prints 36 within sliding drawer 24 at viewing aperture 26 as follows:

When sliding drawer 24 is disengaged or pulled away from frame housing 20 until stopped by the stop members (not shown) described earlier, the bottom-most image print 48 of stack 36 is separated by separator bar 41 from the remainder of stack 36. The separated image print is retained within frame housing 20 and guided toward viewing aperture 26 where it is centered for display while the remainder of stack 36 remains intact within the sliding drawer 24 against the separator bar 41. Engaging or pushing sliding drawer 24 back into frame housing 20, as per arrow 50, now causes the displayed print to be repositioned to the top of stack 36, while it is still centered against viewing aperture 26. To summarize, during each complete cycle of disengagement and engagement of sliding drawer 24 within frame housing 20, that is, pulling sliding drawer 24 out fully away from frame housing 20 and sliding it back fully into frame housing 20 again, one image print is removed from the bottom end of stack 36 and returned to the top end of stack 36. For simplicity, henceforward, the pulling of sliding drawer 24 away from frame housing 20 until stopped by the stop members shall be referred to as full “pull-out”, the pushing of sliding drawer 24 into frame housing 20 until fully engaged shall be referred to as a full “push-in”, and the combination of the two actions in sequence shall be referred to as a full “pull-out/push-in”. Additional details relating to the structure of the described device and particularly the print advancement features including the separating and retaining means, are described in greater detail in the previously referenced U.S. Pat. No. 4,939,860, issued to P. Ackeret on Jul. 10, 1990 and assigned to Licinvist, AG.

Print holder 21 described above and in greater detail in the cross referenced patent provides a convenient means for retaining a stack of image prints and for sequentially advancing each print in the stack for viewing. It will be appreciated from the discussion that follows, however, that other devices capable of retaining and advancing prints are also useful for the present invention herein described and can be substituted for the particularly described structure.

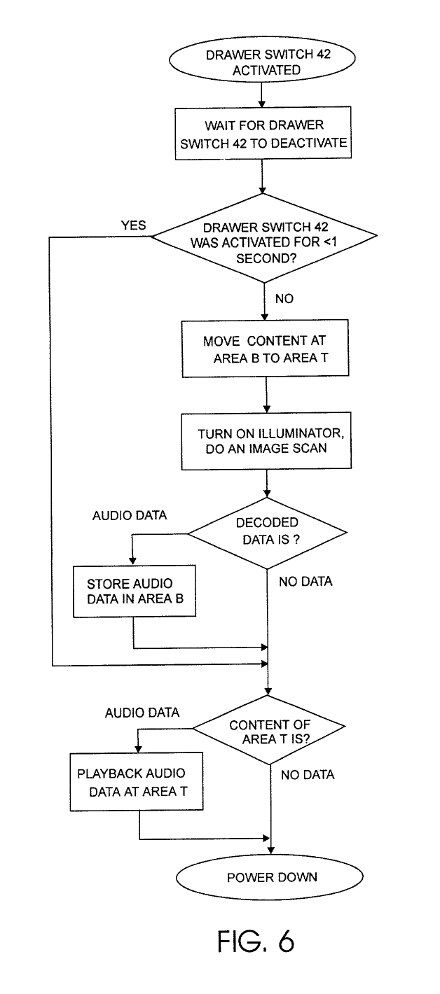

The operation of display apparatus 18 in its totality can now be described by referring to FIGS. 1 to 6, and in particular the logic flow diagram of FIG. 6. All memory areas referenced in FIG. 6 reside in nonvolatile memory 74 so a power-down does not cause loss of data.

Controller 23 is normally in the power-down mode to conserve batteries 82. Upon a user opening sliding drawer 24, drawer switch 42 is activated and starts up processor 72. Processor 72 waits for sliding drawer 24 to be closed again deactivating drawer switch 42. The duration of time that drawer switch 42 is activated is measured by processor 72 and is related to two operational modes of display apparatus 18: first, playing back the audio data associated with image print 49 shown at viewing aperture 26 without causing an advancement of image prints 36, and second, advancing image prints 36 and then playing back the audio data of the newly shown image print 49 under viewing aperture 26.

To play back the audio data associated with image print 49 shown at viewing aperture 26, the user pulls out sliding drawer 24 only partially, just sufficiently to activate drawer switch 42 followed by an immediate pushing in of sliding drawer 24. Due to the inherent design of print holder 21, this partial opening and closing of sliding drawer 24 activates drawer switch 42 only momentarily, preferably less than one second, and does not cause an advancement of an image print.

To advance the image print and play back the audio data of the newly shown image print 49 under viewing aperture 26, the user performs a full pull-out/push-in of sliding drawer 24. The full pull-out/push-in action required to advance an image print inherently takes longer than the above-described partial in/out movement of sliding drawer 24, preferably longer than one second.

First, in the partial in/out movement of sliding drawer 24, when drawer switch 42 is activated for less than one second, processor 72 checks Area T in nonvolatile memory 74 for audio data corresponding top-most image print 49 under viewing aperture 26. If found, processor 72 sends this audio data to digital signal processor 80 for audio playback. If no data is found, no task is executed. In either case, once complete, processor 72 goes into a power-down mode.

Second, when drawer switch 42 is activated for one second or more during a full pull-out/push-in of sliding drawer 24, and bottom-most image print 48 of stack 36 is moved to become top-most image 49 of stack 36 under the viewing aperture 26, processor 72 moves any audio data found at Area B to Area T in order to maintain the correct correspondence between top-most image print 49 under the viewing aperture 26 and its associated audio data. Since image sensor 58 always scans encoded data 54 from bottom-most image print 48 while the top-most image print 49 is what is shown under the viewing aperture 26, processor 72 must move audio data from Area B to Area T to maintain synchronization whenever an image print is advanced. Processor 72 then turns on illuminator 59 and image sensor 58 performs an image scan of encoded data 54 seen through scanning window 52. The scanned image is decoded by processor 72 and the resultant audio data is stored in Area B; this audio data is not to be played back immediately because it belongs to bottom-most image print 48 of stack 36. Processor 72 then checks Area T for audio data belonging to top-most image print 49 that is currently under viewing aperture 26. If audio data is found at Area T, processor 72 sends it to digital signal processor 80 for audio playback. If not, no task is executed. In either case, once complete, processor 72 goes into power-down mode.

In the above description, the mode of operation was determined from the duration of drawer switch 42 activation. Alternatively, a second switch (not shown) located at the stop member (referenced under FIG. 1 but not shown) can be used. This second switch is activated only when sliding drawer 24 is fully disengaged from frame housing 20. Activation of both the second switch and drawer switch 42 would indicate that the user has advanced to the next image print. Still other methods of sensing the mode of operation are possible, including but not limited to optical, magnetic, voice recognition and the like.

FIG. 6 describes the process of playing back of audio data which are already encoded on back surface 46 of the image prints. Next the steps for audio recording and imprinting encoded data 54 on the image prints will be described. Additional equipment and software required for the following steps are described but not shown in figures.

For audio recording, a microphone-equipped computer, a printer and a predetermined audio recording and encoding software will be required. Audio recording software is preferably based on the audio compression algorithm from Cybernetics InfoTech, Inc. of Rockville, Md. referenced earlier. Cybernetics supplies such algorithms in ANSI C code, 16-bit fixed-point C code or Windows 95/NT DLL (dynamic link libraries). Preferably, the audio recording software automatically selects the highest audio data rate that will accommodate the duration of the particular audio recording, hence optimizing the audio quality. Encoding the audio data is preferably based on the PaperDisk™ software from Cobblestone Software, Inc., of Lexington, Mass. referenced earlier. The PaperDisk™ software is for PC compatible, 386 or above, and Windows 3.1 or Windows 95.

As described earlier with respect to FIG. 4, the imprinting process may be accomplished by the user with a computer, a printer and a predetermined software, or by the photo finishing laboratory as a step in the photo finishing process. If the imprinting is done by the user, briefly the steps are as follow for each image print using the predetermined software described above: (a) enter into the computer any textual information desired on the image print, (b) record through the computer microphone an audio message desired for the image print, (c) place the corresponding image print into the printer and activate the printing for imprinting encoded data 54 on its back surface. FIG. 4 shows an example of a typical output. Imprinting directly on back surface 46 of an image print is preferably done using a resin ink thermal transfer printer technology such as Alps MicroDry™ MD-2010 printer manufactured by Alps Electric (USA), Inc. of San Jose, Calif. As an alternative to imprinting directly, encoded data 54 may be imprinted first on an adhesive label using a laser printer or inkjet printer. The label can then be affixed to back surface 46 of an image print.

If the imprinting is to be done as a step in the photo finishing process of the photographic print by the photo finishing laboratory, the photo finishing laboratory will require the user to send in data that is representative of the human readable information and the audio data together with the picture image data. Briefly the steps are as follow: (a) enter into the computer any textual information desired on the image print, (b) record into the computer through the microphone an audio message desired for the image print, (c) send the text data, audio data and image data specific to each image print to the photo finishing laboratory. These data may be transported either physically through the use of traditional storage media such as magnetic media, optical media, solid-state memory device and the like, or electronically through use of email, FTP or Internet and the like. This approach to imprinting encoded data 54 is particularly applicable when a digital camera is used for taking the original picture. There is also little equipment or software required by the photo finishing laboratory to provide such imprinting service to customers.

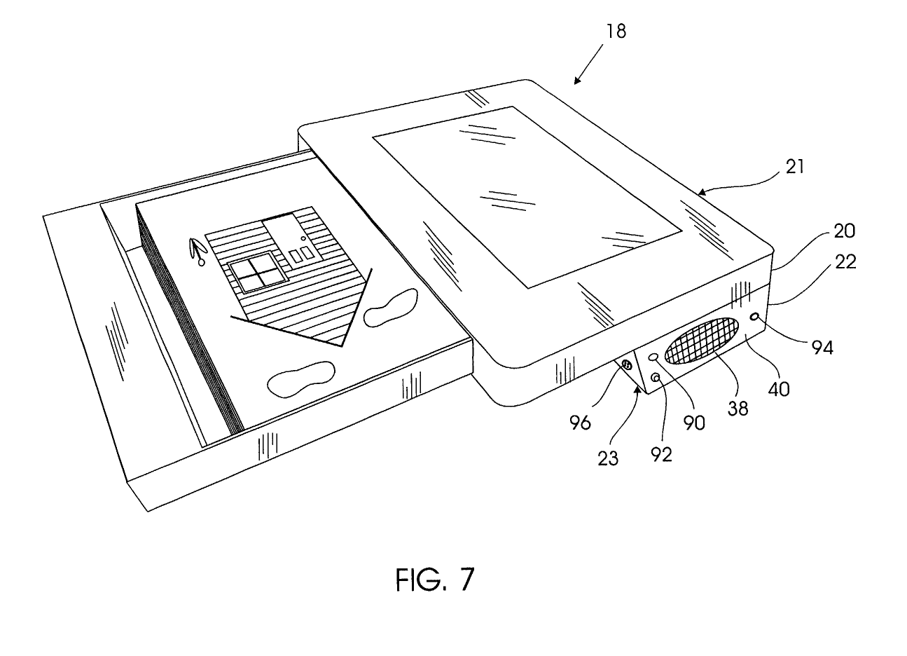

### Description of a Further Preferred Embodiment—FIGS. 7 to 10

A further preferred embodiment of the present invention will now be described in detail. This further preferred embodiment incorporates all of the features of the first preferred embodiment plus additional features that permit audio recording with display apparatus 18, features for associating audio recording to the image print, and features for transferring audio data to an external device for imprinting of encoded data 54.

FIG. 7 shows the above-described additional components attached to exterior supporting surface 40 of controller housing 22, namely a microphone 90, a record switch 92 for activating audio recording, a transceiver 94 for wireless communication with external devices (not shown), and a data connector 96 for wired communication with external devices (not shown). Transceiver 94 preferably utilizes the industry standard IrDA (infrared data association) serial protocol technology. Data connector 96 provides for a wired connection to external devices, preferably via a serial interface.

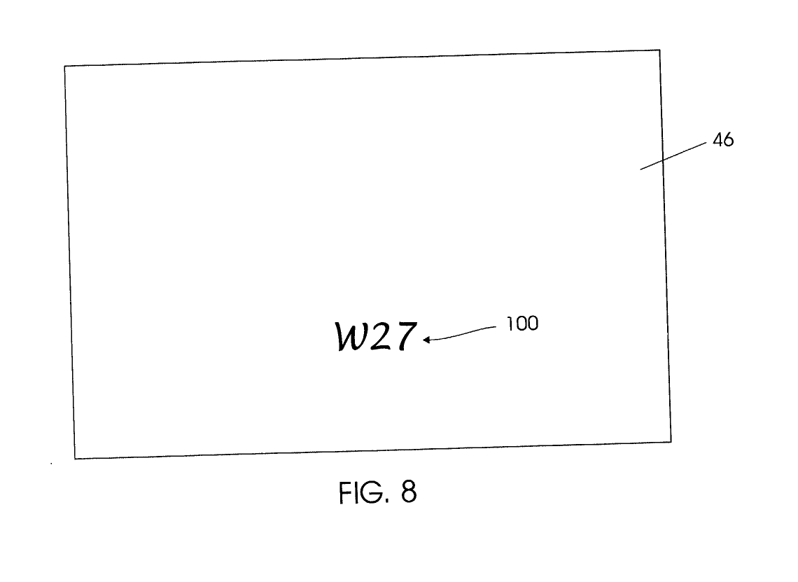

FIG. 8 shows an exemplary layout of back surface 46 of an image print representing the first step in the annotation process of this further preferred embodiment. A unique picture identification marking (“PID”) 100 designated by the user is handwritten on back surface 46 of an image print. Preferably, PID 100 is limited to a three-character alphanumeric writing for ease of decoding by processor 72. PID 100 is placed on back surface 46 of an image print in a location where it will be substantially centered within scanning window 52 when the image print is the bottom-most image print 48 at the bottom of sliding drawer 24, and sliding drawer 24 is fully engaged within frame housing 20. Preferably PID 100 is easily removable as it serves only to temporarily associate an image print to its corresponding audio data during the annotation process and will not be required after the imprinting of encoded data 54. A number of marking apparatuses exist on the market which can be easily erased. One example is the Erasemate™ Pen manufactured by PaperMate™ in which the ink from the pen can be erased as easily as pencil marks. Alternatively, PID 100 may be handwritten on a removable adhesive label and affixed to back surface 46 of an image print. The label could then be removed prior to imprinting of encoded data 54.

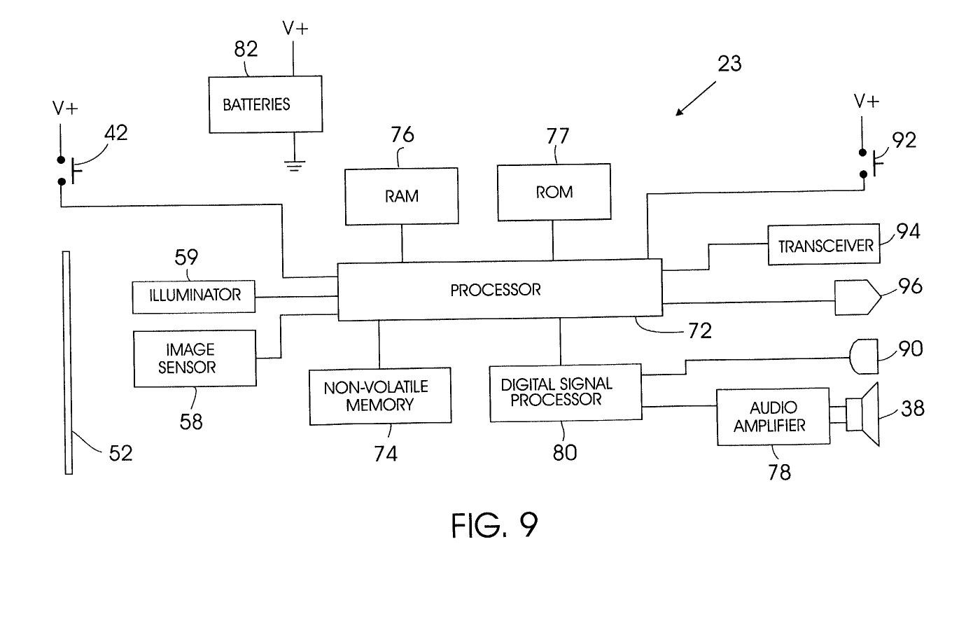

FIG. 9 shows the additional electrical components of controller 23 in the further preferred embodiment of the present invention, namely microphone 90, which is preferably a subminiature type which is conventionally known, record switch 92 for activating audio recording, transceiver 94 for wireless communication with external devices (not shown), and data connector 96 for wired communication with external devices (not shown). Analog signals from microphone 90 are first converted into digital format by the A/D function of digital signal processor 80 and then compressed into audio data by the codec function of digital signal processor 80. Transceiver 94 preferably utilizes the industry standard IrDA (infrared data association) serial protocol technology, or alternatively may comprise a RF transmitter and receiver pair, or other well known wireless communication devices and protocols. Data connector 96 provides for a wired connection to external devices, preferably via a serial interface, but may also be parallel or any other suitable input-output interface to effect digital data transfer.

Nonvolatile memory 74 has additional memory allocation beyond that described in the first preferred embodiment above. A discrete storage area is logically allocated within nonvolatile memory 74 to hold catalog (not shown) information. The catalog is a list of entries consisting of two fields: the PID 100 and a PID address (not shown). The PID address points to an area in nonvolatile memory 74 for storing audio data corresponding to PID 100. The catalog can be implemented on a perpetual first-in first-out (FIFO) basis by keeping a predetermined number of the most current PID 100 entries.

Processor 72 has additional functions of decoding handwriting and synthesizing speech. The function of decoding handwriting is performed through a process commonly known as Optical Character Recognition (OCR), and more specifically, handwriting recognition (HWR). Algorithms for handwriting recognition are available from a number of commercial sources. The applicant has found the Allegro handwriting recognition system from Fonix Corporation of Salt Lake City, Utah to be particularly useful. Such an algorithm is incorporated into read-only memory 77. Preferably PID 100 is limited to a three-character alphanumeric writing for ease of decoding. Alternatively, PID 100 may contain a variable length of alphanumeric characters for increased versatility. The function of synthesizing speech is performed through an algorithm called text-to-speech whereby input in the form of text data is synthesized into human recognizable speech. There are many commercially available text-to-speech algorithms on the market and are conventionally known to those skilled in the art. Such an algorithm is also incorporated into read-only memory 77.

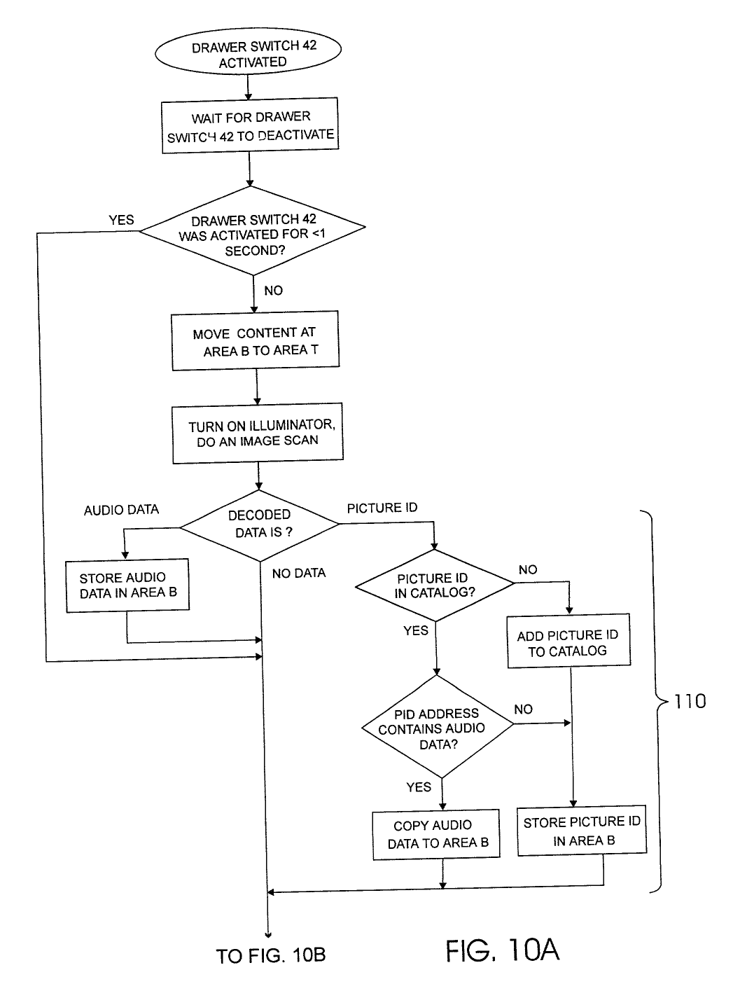

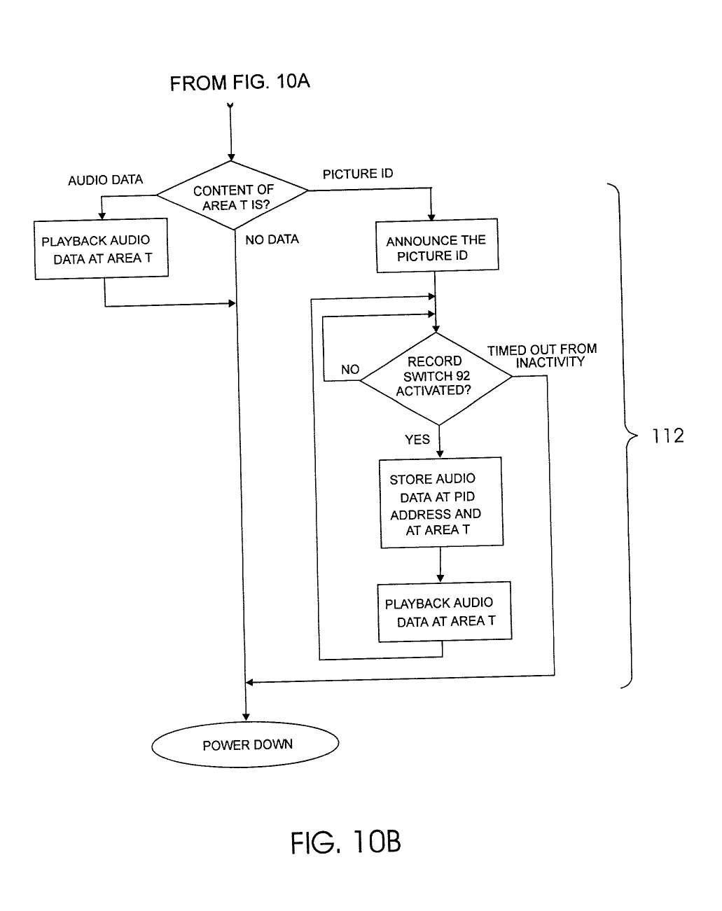

### Operation of a Further Preferred Embodiment—FIGS. 10A to 10B

The further preferred embodiment of the present invention incorporates all of the functions of the first preferred embodiment plus additional functions of audio recording, associating audio recording to the image print, and transferring audio data to external devices for imprinting of encoded data 54. In this further preferred embodiment, audio recording can be done directly using display apparatus 18, whereas in the first preferred embodiment, the annotation procedure required the use of a separate computer to conduct the audio recording. Hence, this further preferred embodiment has the advantage that audio recording can be done anywhere. A computer and a printer are needed only at the time of imprinting encoded data 54 on the image prints.

Audio recording using display apparatus 18 will be described first followed by the imprinting of encoded data 54 on the image prints.

FIG. 10A and 10B are the logical flow diagrams of this further preferred embodiment. A comparison will show that the logic flow for this further preferred embodiment is an extension of the first preferred embodiment logic flow with the addition of two routines: a routine 110 to process PID 100 information and a routine 112 to perform audio recording. Other processes are the same as in the first preferred embodiment. The two additional routines 110 and 112 will now be described. All memory areas referenced in FIG. 10 reside in nonvolatile memory 74 so a power-down does not cause loss of data.

Prior to loading the stack of image prints 36 into display apparatus 18, the user places a unique handwritten PID 100 on back surface 46 of each image print. These unique PID 100 are used by the present invention to associate audio recording with each image print. PID 100 is written on the image print in a location where it will be substantially centered within scanning window 52 when the image print is the bottom-most image print 48 in sliding drawer 24, and sliding drawer 24 is fully engaged within frame housing 20. Preferably PID 100 is limited to a three-character alphanumeric writing, and is easily removable after use.

Assume now that the stack of image prints 36 described above have been loaded into sliding drawer 24. Referring to FIG. 10A, the entry point to routine 110 starts when the decoded data is found to contain PID 100. PID 100 of the bottom-most image print 48 will not be found in the Catalog since this was the start of the new stack of image prints 36. Therefore, an entry will be added to the catalog containing this PID 100 and its corresponding PID address. The PID 100 itself is also stored in Area B of nonvolatile memory 74. To understand and follow what happens next, consider that the bottom-most image print 48 is now advanced to become the top-most image print 49. As this occurs, the content of Area B is moved to Area T. Referring now to FIG. 10B, the entry point to routine 112 starts when the content of Area T is found to contain PID 100. PID 100 from Area T is announced through loudspeaker 38 so the user has an audio confirmation of the identity of top-most image print 49 currently shown under viewing aperture 26. The announcement is in the form of synthesized speech generated by the text-to-speech algorithm and the digital signal processor 80. Each alphanumeric character is announced one at a time such as “double-u . . . two . . . seven” using the example of PID 100 shown in FIG. 8. Processor 72 waits for the user to activate record switch 92 to do an audio recording for top-most image print 49. For the duration that record switch 92 is activated, processor 72 stores audio data at the PID address corresponding to PID 100, and also into Area T. Upon deactivation of record switch 92, processor 72 plays back the stored audio data from Area T through loudspeaker 38 for user verification. If, after the audio replay, the user is dissatisfied, a new recording can be made by depressing record switch 92 again and repeating the process. There is a time-out feature whereby if record switch 92 remains idle or not activated for a predetermined time, preferably after thirty seconds, it will be assumed that the user does not want to make or further modify a recording, then processor 72 goes into power-down mode. As can be observed from routine 112, once record switch 92 has timed out, there is no provision to modify an existing audio recording. Such a provision has been omitted from the flow diagrams for simplicity. Other alternative modes of starting and stopping recording are also possible. For example, activating record switch 92 may give the user a fixed time duration in which to make an audio recording, or audio recording may be started by activating record switch 92 once, and stopped by activating record switch 92 once again.

The above description refers to the situation where PID 100 did not initially exist in the catalog. When PID 100 already exists in the catalog (referring back to FIG. 10A routine 110), processor 72 checks to see if the corresponding PID address for PID 100 contains audio data. If audio data is found, it means the user had previously made an audio recording for this image print, so processor 72 copies this audio data to Area B. The remaining steps in the logic flow diagram show the play back of this audio data when this image print is advanced to the top-most image print 49 of the stack 36. If no audio data is found, it means the user has not yet made an audio recording for this image print, so processor 72 stores PID 100 in the Area B, and the user will be given an opportunity to make an audio recording for this image print in the same manner as described before.

After completing the above-described process for each image print in stack 36, each image print will have an associated audio recording stored in nonvolatile memory 74 of display apparatus 18. The next step of imprinting encoded data 54 on back surface 46 of the image prints will now be described.

Preferably, transceiver 94 communicates through wireless means to transfer PIDs 100 and their associated audio data from nonvolatile memory 74 of display apparatus 18 to a computer, eliminating the need for a physical link. Where a wireless link is not available, data connector 96 is used to transfer the data by wired means. Data transfer is initiated by activating predetermined software on the computer. Once PIDs 100 and their associated audio data have been transferred to the computer, the remaining imprinting process is the same as that described above with respect to the first preferred embodiment. The only exception is that just prior to putting the image print into the printer for imprinting encoded data 54, PID 100 is removed as it is no longer needed once the associated audio data is encoded on back surface 46 of the image print.

In routine 112 of FIG. 10B, digital signal processor 80 preferably uses the highest audio data rate for audio recording. Then, prior to the imprinting of encoded data 54 on the back surface 46 of the image print, the software on the computer selects the highest audio data rate that will accommodate the duration of the associated audio recording so as to maximize the audio quality of encoded data 54.

While PID 100 is a temporary marking to serve the end purpose of imprinting encoded data 54 on the correct corresponding image print, a user may choose to operate display apparatus 18 using PID 100 indefinitely without ever imprinting encoded data 54 on the image prints. Such usage is limited only by the amount of audio recording storage capacity of nonvolatile memory 74.

### Additional Preferred Embodiments

Additional preferred embodiments are described below but are not shown in the accompanying figures.

In another preferred embodiment, controller housing 22 with controller 23 parts housed therein is detachably mounted to frame housing 20. When controller housing 22 is separated from frame housing 20, this self-contained controller 23 can scan and playback encoded data 54 from photographic prints even if the prints are stored inside photo albums, provided that back surface 46 of the photographic prints are visibly accessible to the optical components of controller 23. In this embodiment, controller 23 is held against back surface 46 of a photographic print, a playback switch (not shown) is activated causing controller 23 to scan an image, decode encoded data 54, and then play back the decoded audio data. This embodiment of the present invention has broad application beyond image prints and associated audio recording, such as transferring non-audio data from printed sheets to an electronic hand-held device.

In still another preferred embodiment, nonvolatile memory 74 is detachably mounted to controller 23 so that it may then be physically removed from controller housing 22 and inserted into a computer or other imprinting device to effect the transfer of data to the computer. This also has the advantage of allowing a large number of annotations to be completed at one time by simply detaching nonvolatile memory element 74 whenever it becomes “full” and replacing it with another nonvolatile memory element 74 to continue the annotation with other image prints.

In yet another embodiment, encoded data 54 may contain text data instead of audio data, whereby such text data is played back as synthesized speech through text-to-speech conversion. This arrangement has the advantage of allowing a longer audio playback than is possible through the digitization of human speech. This embodiment has many broad applications, such as for example in children's story books whereby a long narrative story may accompany each picture card, or it may act as a reading device for the visually impaired.

In another embodiment, the function of the computer and printer is replaced by a self-contained standalone device capable of: (a) audio recording or receiving digital audio data from display apparatus 18, (b) digitizing and compressing the recorded audio into audio data, (c) taking in an image print from an input tray, imprinting encoded data 54 onto back surface 46 of the image print and transporting it to an output tray. Such a self-contained device has the advantage of compactness.

Still other preferred embodiments are described below which use different materials for the viewing aperture. New materials are described below but are not shown in the figures.

In one further preferred embodiment, the viewing aperture 26 is made of a clear or transparent touch sensitive screen material (not shown). Preferably the touch screen is based on the analog resistive type technology allowing finger, gloved hand or stylus activation. Touch screen technology is conventionally known to those skilled in the art. The electrical output of the touch screen is connected to processor 72 and processed as user input information. In this arrangement, encoded data 54 on each image print conveniently comprises machine instruction, text data and the like, relevant to the respective image print. Thus, when an image print is advanced to viewing aperture 26, the machine instruction contained within encoded data 54 is executed in conjunction with user input from the touch screen. In operation, therefore, a user can interact with display apparatus 18 by means of activating specific areas of the touch screen corresponding to the information visible through viewing aperture 26. For example, when used as a child's learning aid, an image print may contain pictures of several different animals. Encoded data 54 for that image print will contain pertinent information relating to the location of each animal on the image print. When a user presses the area of the touch screen corresponding to a particular animal as indicated by encoded data 54, display apparatus 18 plays back the name of the animal through speech synthesis such as: “This is a tiger.” When the user advances to the next image print, different animals are shown and encoded data 54 corresponding to the new image print is read and stored. Hence different messages are played back when different areas on the touch screen are activated. Alternatively, the display apparatus may ask the user: “Where is the tiger?”, to which the user is expected to touch that area of the touch screen where the tiger is seen. In another example of a use of the present invention as a child's learning aid, each image print may contain letters of the alphabet. The user is instructed to hand trace the letter shown using a stylus on the touch screen. The hand tracing is then analyzed by processor 72 by means of handwriting recognition or simple pattern matching algorithms. A congratulatory message is played back to the user if the tracing was done correctly.

In another preferred embodiment, viewing aperture 26 is made of liquid crystal display (LCD) material (not shown). Preferably the LCD is a transmissive type allowing light to pass through the LCD, hence images on the LCD appear as an overlay to the image print visible under viewing aperture 26. For increased visibility, a light source (not shown) may be located directly beneath viewing aperture 26 to provide illumination to the front surface of the image print. Transmissive LCD technology is conventionally known to those skilled in the art. The LCD is electrically connected to processor 72 and serves to provide dynamically changeable visual information to the user. Encoded data 54 on each image print comprises machine instruction, text data and the like, relevant to the respective image print. Thus, when an image print is advanced to viewing aperture 26, the machine instruction contained therein is executed and information is displayed on the LCD accordingly. In operation, when a user advances an image print to viewing aperture 26, processor 72 plays back audio information through loudspeaker 38 and visual information through the LCD display. The visual information on the LCD may also create an animation effect by means of activating successive areas of the LCD screen against the static background picture of the image print. For example, when used as a child's story book, a boy may be represented by a simple stick-figure displayed on the LCD against the background picture of buildings. Processor 72 plays back the story lines through speech synthesis such as: “See Johnny leave his house. See Johnny walk by grandma's house. See Johnny go to the school.”; while successively activating the areas of the LCD corresponding to where Johnny is according to the narration, hence creating an animation effect of Johnny walking from his home to his school. When the user advances to the next image print, different picture and story lines are read from encoded data 54 and then played back as described above.

In yet another preferred embodiment, the features of the touch screen and the LCD described above are simultaneously incorporated into display apparatus 18. The result is an interactive display apparatus that can both accept user input information and output information to the user. For example, when used as a child's question and answer response tool, the user may be asked to select all the objects shown on an image print that belong in the kitchen, such as pots and pans. As the user selects each correct object through the touch screen, a check mark appears on the LCD corresponding to where the object is located on the image. When all the objects have been selected correctly, a congratulatory message is played back to the user. Furthermore, the user responses may be stored in nonvolatile memory 74 and output to an external device such as a computer for record keeping of the correct responses. This data may be transferred either through the use of data connector 96 or transceiver 94.

Thus, the reader will appreciate that the above-described method and apparatus for annotating image prints are convenient, efficient, economical and reliable. The resulting annotation will last as long as the image print itself and will not degrade with use or over time, nor be subject to accidental erasure. The capability of including audio annotation greatly improves the documentation, story telling, and memory stimulation features of image prints, thus enhancing the primary purposes of still image photography. Both old and new photographic prints may be annotated without the need to purchase elaborate and expensive equipment.

The above is a detailed description of particular preferred embodiments of the invention. Those with skill in the art should, in light of the present disclosure, appreciate that obvious modifications of the embodiments disclosed herein can be made without departing from the spirit and scope of the invention. All of the embodiments disclosed and claimed herein can be made and executed without undue experimentation in light of the present disclosure. The full scope of the invention is set out in the claims that follow and their equivalents. Accordingly, the claims and specification should not be construed to unduly narrow the full scope of protection to which the present invention is entitled.

What is claimed is:

1. A display apparatus including display means for holding a plurality of image prints and for displaying the image prints successively in a viewing aperture, and advance means for sequentially advancing the image prints one at a time to said viewing aperture, comprising:
scanning means for scanning a machine-readable data on a back surface of at least one of the plurality of image prints, said machine-readable data being integral to said back surface of said at least one image print;
decoding means for decoding said machine-readable data wherein said machine-readable data comprises audio data, machine data, or text data;
storage means for storing said decoded machine-readable data corresponding to said at least one scanned image print; and
playback means for playing back from said storage means said decoded machine-readable data corresponding to said at least one scanned image print when said at least one scanned image print is displayed at said viewing aperture,
whereby said display apparatus is convenient for both displaying image prints and for playing back said corresponding decoded machine-readable data.

2. An apparatus according to claim 1, wherein said scanning means is an image sensor.

3. An apparatus according to claim 1, wherein said machine-readable data is a two-dimensional encodement.

4. An apparatus according to claim 1, wherein said storage means is a nonvolatile storage element.

5. An apparatus according to claim 1, further including a voice synthesis means for synthesizing speech from said machine-readable data.

6. An apparatus according to claim 1, further including a transfer means for transferring said machine-readable data to an external device.

7. An apparatus according to claim 1, further including input means for accepting user input from a touch screen.

8. An apparatus according to claim 1, further including output means for outputting said decoded machine-readable data for display on an electronic display device.

9. A display apparatus comprising display means for holding a plurality of image prints and for displaying the image prints successively in a viewing aperture, and advance means for sequentially advancing the image prints one at a time to said viewing aperture, comprising:
scanning means for scanning a handwritten indicia on the back surface of at least one of the plurality of image prints;
decoding means for decoding said scanned indicia wherein said indicia contains identification information unique to said at least one scanned image print;
recording means for recording audio corresponding to said at least one scanned image print;
storage means for storing said recorded audio corresponding to said at least one scanned image print at a unique storage location uniquely associated with said identification information;
playback means for playing back from said unique storage location said recorded audio corresponding to said at least one scanned image print when said at least one scanned image print is displayed at said viewing aperture,
whereby said indicia provides a means to correspond said at least one image print with said corresponding audio recording, and
whereby said display apparatus is convenient for both displaying image prints and playing back audio associated with said image prints.

10. An apparatus according to claim 9, wherein said scanning means is an image sensor.

11. An apparatus according to claim 9, wherein said decoding means is optical character recognition processing.

12. An apparatus according to claim 9, wherein said storage means is a nonvolatile storage element releasably attached to said display apparatus.

13. An apparatus according to claim 9, further including voice synthesis means for synthesizing speech.

14. An apparatus according to claim 9, further including transfer means for transferring said recorded audio to an external device.

15. A method for sequentially displaying a stack of image prints in a display apparatus, comprising the steps of:
i) placing said stack of image prints into said display apparatus;
ii) scanning a machine-readable data from a back surface of a bottom-most stacked image print wherein said machine-readable data comprises audio data, machine data, or text data, and wherein said machine-readable data is integral to said back surface of said bottom-most stacked image print;
iii) decoding said scanned machine-readable data corresponding to said bottom-most stacked image print and storing said scanned machine-readable data corresponding to said bottom-most stacked image print in a storage means;
iv) advancing said bottom-most stacked image print to a top-most position of the stack and into a viewing aperture;
v) playing back said decoded scanned machine-readable data stored in said storage means corresponding to said top-most stacked image print displayed in said viewing aperture,
whereby said display apparatus is convenient for both displaying image prints and playing back said machine-readable data associated with said image prints

16. A method as claimed in claim 15, wherein said display apparatus comprises a frame housing which retains said bottom-most stacked image print, and a sliding drawer for retaining the remainder of said stacked image prints, said sliding drawer slidable within said frame housing between a first fully-in position and a second fully-out position, and comprising the further steps of:
i) moving said sliding drawer from said fully-in position to said fully-out position thereby causing said bottom-most image print to advance into said viewing aperture;
ii) moving said sliding drawer from said fully-out position back to said fully-in position thereby causing the remainder of the stacked image prints to be positioned below said bottom-most image print and causing said bottom-most image print to be moved to said top-most position of the stack of image prints, and simultaneously scanning said machine-readable data on a succeeding bottom-most image print for decoding and storing in said storage means;
iii) the movement of said sliding drawer from said fully-in position to said fully-out position and back to said fully-in position causing said display apparatus to play back said decoded machine-readable data stored in said storage means corresponding to said top-most image print displayed in said viewing aperture,
whereby said display apparatus cyclically rearranges said stack of image prints within said display apparatus.

17. A method as claimed in claim 15, wherein said display apparatus further includes a touch screen disposed at said viewing aperture, said touch screen providing a touch input means for a user to interact with said top-most image print displayed in said viewing aperture.

18. A method as claimed in claim 15, wherein said display apparatus further includes an electronic display device providing an output means to electronically display visual information to a user.

19. A method of sequentially displaying a stack of image prints in a display apparatus, comprising the steps of:
i) placing said stack of image prints into said display apparatus;
ii) scanning a handwritten indicia on a back surface of a bottom-most stacked image print;
iii) decoding said scanned indicia wherein said indicia contains identification information unique to said bottom-most stacked image print;
iv) advancing said bottom-most stacked image print to a top-most position of the stack and into a viewing aperture;
v) recording an audio corresponding to said top-most stacked image print;
vi) storing said recorded audio corresponding to said top-most stacked image print in a storage means at a storage location uniquely associated with said identification information corresponding to said top-most stacked image print;
vii) playing back from said storage means said recorded audio corresponding to said top-most stacked image print displayed at said viewing aperture of said display apparatus,
whereby said indicia provides a means to correspond said top-most stacked image print with said corresponding audio recording, and
whereby said display apparatus is convenient for both displaying image prints and playing back audio associated with said image prints.

20. A method as claimed in claim 19, wherein said display apparatus comprises a frame housing which retains said bottom-most stacked image print and a sliding drawer for retaining the remainder of said stacked image prints, said sliding drawer slidable within said frame housing between a first fully-in position and a second fully-out position, and comprising the further steps of:
i) moving said sliding drawer from said fully-in position to said fully-out position, thereby causing said bottom-most image print to advance into said viewing aperture;
ii) moving said sliding drawer from said fully-out position back to said fully-in position thereby causing the remainder of the stacked image prints to be positioned below said bottom-most image print and causing said bottom-most image print to be moved to a top-most position of the stack of image prints, and simultaneously scanning said handwritten indicia on a succeeding bottom-most image print for decoding and storing in said storage means;
iii) the movement of said sliding drawer from said fully-in position to said fully-out position and back to said fully-in position causing said display apparatus to play back said recorded audio stored in said storage means corresponding to said top-most image print displayed in said viewing aperture,
whereby said display apparatus cyclically rearranges said stack of image prints within said display apparatus.

21. A method as claimed in claim 15, wherein said machine-readable data is made integral to said back surface of said bottom-most stacked image print by a method comprising the steps of:
i) making an audio recording corresponding to said bottom-most stacked image print using a recording device;
ii) converting said audio recording into said machine-readable data using an algorithmic encoding process, wherein said machine-readable data is a two-dimensional encodement format; and
iii) printing said machine-readable data using a printing device and integrating said machine-readable data with said back surface of said bottom-most stacked image print,
whereby said audio recording is made integral to said bottom-most stacked image print.

22. A method as claimed in claim 19, including the further steps of:
i) outputting from said display apparatus a recorded audio corresponding to at least one of said stacked image prints;
ii) converting said at least one audio recording into a machine-readable data using an algorithmic encoding process, wherein said machine-readable data is a two-dimensional encodement format;
iii) printing said machine-readable data using a printing device and integrating said machine-readable data with a back surface of said at least one corresponding image print,
whereby said audio recording is made integral to said at least one corresponding image print.

23. A method of recording a machine-readable data on a back surface of an image print, the machine-readable data representative of an audio recording corresponding to the image print, comprising the steps of:
i) outputting the audio recording from a display apparatus used to record the audio recording;
ii) converting the audio recording into said machine-readable data using an algorithmic encoding process, wherein said machine-readable data is a two-dimensional encodement format;
iii) printing said machine-readable data using a printing device and integrating said machine-readable data with the back surface of the corresponding image print,
whereby the audio recording is made integral to the image print.
